(19) United States
(12) Patent Application Publication
(10) Pub. No.: US 2005/0080922 A1
(43) Pub. Date: Apr. 14, 2005

(54) Address translation program and address translation apparatus

(75) Inventor: Kouji Sugisawa, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/834,460

(22) Filed: Apr. 29, 2004

(30) Foreign Application Priority Data
Oct. 9, 2003 (JP) 2003-351288

(51) Int. Cl. G06F 15/16; G06F 15/173

(52) U.S. Cl. 709/238; 709/245

(57) ABSTRACT

In an address translation program, a computer performs a procedure 2 of allocating a received packet to a predetermined address translation unit in a plurality of address translation units, a procedure 3 of determining whether or not a target packet of address translation satisfies an address translation unit switching condition, a procedure 4 of repeating the procedure 2 and the subsequent procedures when the switching condition is not satisfied, and switching an address translation unit when the switching condition is satisfied, and a procedure of repeating the procedure 2 and the subsequent procedures.

### BACKGROUND OF THE INVENTION

1. Field of the Invention

The present invention relates to a system of translation a network address, and more specifically to an address translation program and an address translation apparatus for performing high-speed address translation by changing for each packet a layer on which address translation is to be performed.

2. Description of the Related Art

When communications are established between networks having different address systems, for example, an address translation apparatus is provided at the juncture of the networks so that the address translation can be executed. Since there is a shortage of conventionally used IPv (Internet protocol version) 4 addresses, an IPv6 has been developed by expanding the address space into 128 bits. Between the IPv4 network and the IPv6 network, address translation is required for communications.

That is, although the IPv6 network has become commercially practical, a combination of the IPv6 network and the IPv4 network is used for the time being for an efficient use of the existing resources, and it is considered that the address translation between the two networks is an indispensable technology.

FIGS. 1 through 3 are explanatory views of the conventional system for address translation. FIG. 1 is an explanatory view of the address translation by an IP layer. If there is no data on which the address translation is performed in the data to be processed by an application layer, and the communications can be established between the network having different address systems by translating the source address (and a port number) and the destination address (and a port number) of a packet stored in the IP header of the packet, then the address translation is performed by the IP layer.

FIG. 2 is an explanatory view of the address translation by the application layer. If there is data on which the address translation is to be performed in the application data of a packet, for example, if communications are performed with the address of a communications device stored in the data to perform an authenticating process with a partner communications device, then it is necessary to perform the address translation on the packet in the communications connection by the application layer. That is, an IP address stored in the header portion of a packet can be translated by the IP layer. However, an address, etc. is contained in the application data, the data cannot be translated by the IP layer.

FIG. 3 is an explanatory view of selecting an address translation layer through a connection. Between the networks having different address systems, a plurality of connection are made among the communications devices of the respective networks. If a communications is established on the whole, the entire process can be performed at a high speed by selecting a connection for which address translation is to be performed by the application layer or a connection for which address translation is to be performed by the IP layer.

However, there has been the problem that the address translation has to be performed on all packets by the application layer when communications are performed as a connection, and packets to be address-translated by the application layer and a plenty of packets to be translated by the IP layer are transferred in the connection.

The conventional technology of the above-mentioned address translation can be Japanese Patent Application Laid-open No. 2000-156709 “Address Translation Apparatus and Storage Medium”.

The following technology is disclosed in this literature. That is, in a connection of transferring a packet containing data to be address-translated in an application data unit, the address information in the user data unit of all packets in the connection is translated by the application layer, and in a connection of transmitting only packets containing no data to be address-translated in the data unit, all packets are address-translated by the IP layer, thereby quickly performing the communications.

Generally when communications are performed with a plurality of connections in one communication, for example, one connection is made for control as in a file transfer protocol (FTP) while another connection is made for data transmission, a different port number is assigned to each connection. For example, as shown in FIG. 2 of the above-mentioned literature, a connection using a call control port number and a connection using a call port number are made to perform the entire communications.

However, in this literature, the address information in the user data unit of all packets in a connection requiring address translation on the data in the user data unit as explained by referring to FIG. 3, that is, a call control connection, is translated by the application layer, and address translation is performed by the IP layer on all packets in the call connection in which only packets containing no data to be address-translated are transmitted.

Thus, in the conventional technology, when a layer by which address translation is performed is selected, the selection is made in a connection unit. When communications are performed in one connection, and packets containing data requiring address translation in the user data unit (application data) are transmitted, a layer for address translation cannot be selected, and all packets transmitted in the connection are to be address-translated by the application layer. Accordingly, there has been the problem that the throughput required in address translation increases, and a high-speed address translation and communications cannot be performed.

On the other hand, high-speed address translation and communications can be performed by the IP layer, but the presence of data to be address-translated in the application data cannot be recognized, and the address translation cannot be performed on the data.

### SUMMARY OF THE INVENTION

The present invention has been developed to solve the above-mentioned problems, and aims at realizing high-speed address translation and entire communications by determining whether or not data requiring address translation is contained in the application data in a packet unit, and the address translation is performed by the application layer only on the packets requiring the address translation by the application layer.

First, the principle of the address translation program corresponding to the first embodiment of the present invention is explained below. The address translation program is used by a computer for performing address translation depending on a connection in which a packet containing data requiring address translation and a packet containing no such data are transmitted using a plurality of address translation units, for example, an address translation unit for performing address translation by the IP layer and an address translation unit for performing address translation by the application layer.

This program is used to direct a computer to perform the procedure of determining an address translation unit for performing address translation depending on the contents of a data unit of a received packet, and a procedure of allocating a received packet to a determined address translation unit.

According to the program of the first embodiment, a portable computer-readable storage medium storing the program is used. Furthermore, an address translating method for the program is used, and an address translation apparatus for performing address translation is provided at the juncture of two networks having different address systems.

### BRIEF DESCRIPTION OF THE DRAWINGS

FIG. 1 is an explanatory view of the conventional system (1) of address translation;

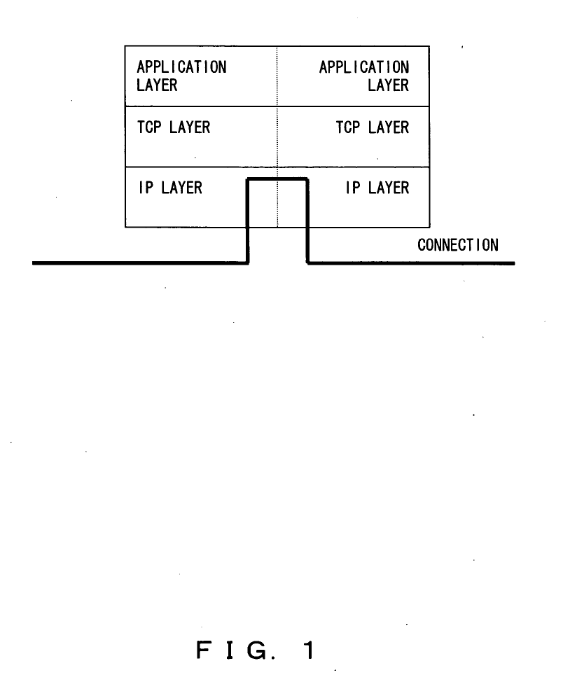

FIG. 2 is an explanatory view of the conventional system (2) of address translation;

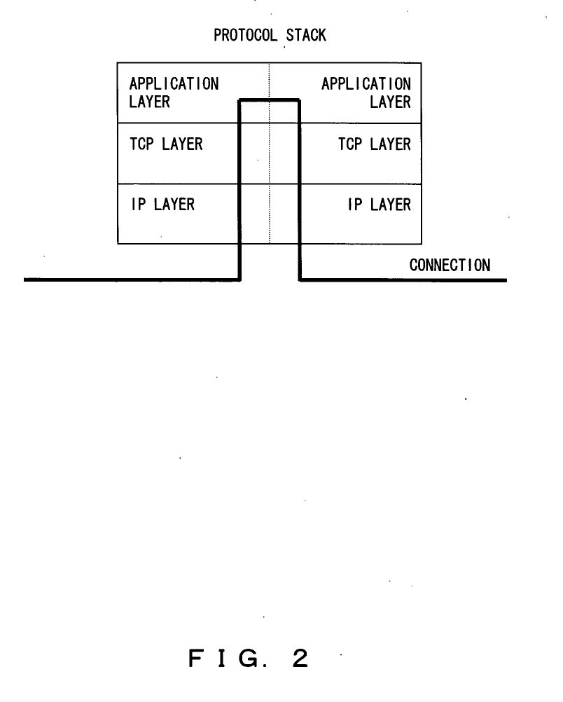

FIG. 3 is an explanatory view of the conventional system (3) of address translation;

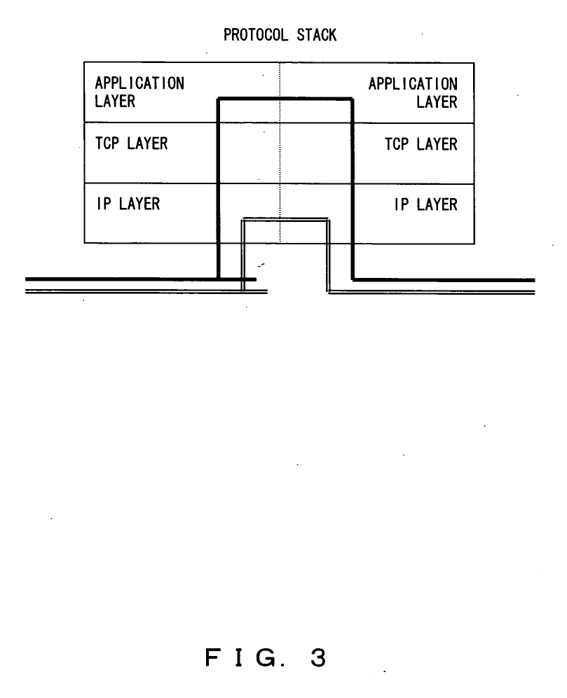

FIG. 4 is a block diagram of the entire configuration of the communications system including the address translation apparatus;

FIG. 5 is a block diagram of the configuration of the address translation apparatus;

FIG. 6 is an explanatory view of the address translation system according to the first embodiment of the present invention;

FIG. 7 is a flowchart of the basic process of address translation according to the first embodiment of the present invention;

FIG. 8 is a block diagram of showing the function in the principle of the address translation program according to the second embodiment of the present invention;

FIG. 9 is an explanatory view showing the address translation system according to the second embodiment of the present invention;

FIG. 10 is a flowchart of the basic process of address translation according to the second embodiment of the present invention;

FIG. 11 is an explanatory view of the communications process in the application (1);

FIG. 12 shows the format of a packet in the application (1);

FIG. 13 shows the format of the TCP header shown in FIG. 12;

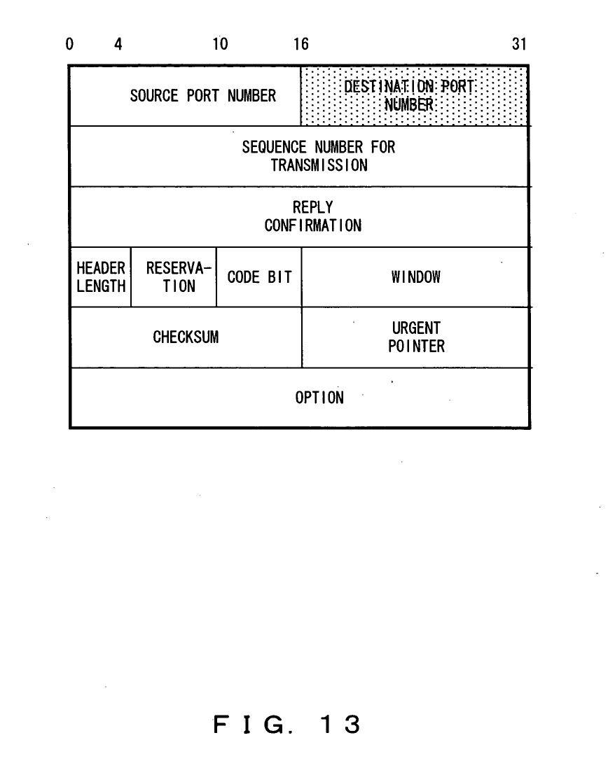

FIG. 14 shows the format of the application header shown in FIG. 12;

FIG. 15 shows the format of the application data (1) shown in FIG. 12;

FIG. 16 shows the format of the application data (2) shown in FIG. 12;

FIG. 17 shows the format of the application data (3) shown in FIG. 12;

FIG. 18 is an explanatory view of the communications process in the application (2);

FIG. 19 shows the format of the application header in the application (2);

FIG. 20 shows the format of the application data of the display data transmission packet in the application (2);

FIG. 21 is an explanatory view of the communications process in the application (3);

FIG. 22 shows the format of the application header in the application (3);

FIG. 23 shows the format of the application data of an information transmitting packet, and an information transmission termination packet;

FIG. 24 is a flowchart of the address translating process in the application (1) according to the first embodiment of the present invention;

FIG. 25 is a flowchart of the address translating process in the application (2) according to the first embodiment of the present invention;

FIG. 26 is a flowchart of the address translating process in the application (3) according to the first embodiment of the present invention;

FIG. 27 is a flowchart of the address translating process in the application (1) according to the second embodiment of the present invention;

FIG. 28 is a flowchart of the address translating process in the application (2) according to the first embodiment of the present invention;

FIG. 29 is a flowchart of the address translating process in the application (3) according to the second embodiment of the present invention; and

FIG. 30 is an explanatory view of loading the program according to the present invention into a computer.

### DESCRIPTION OF THE PREFERRED EMBODIMENTS

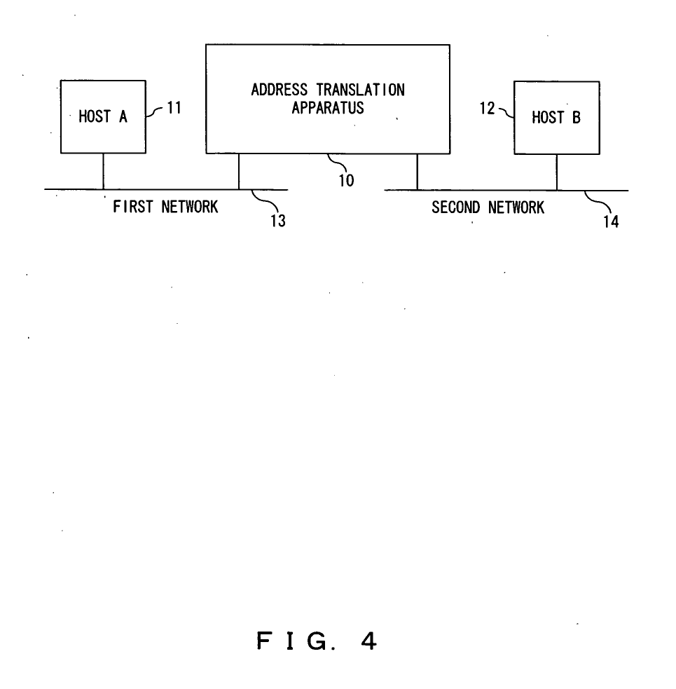

The embodiments of the present invention are described below in more details. FIG. 4 shows the configuration of the entire communications system including the address translation apparatus. In FIG. 4, an address translation apparatus 10 performs address translation in the packet communications between a host A 11 and a host B 12, and is provided at the juncture between a first network 13 to which the host A 11 is connected and a second network 14 to which the host B 12 is connected.

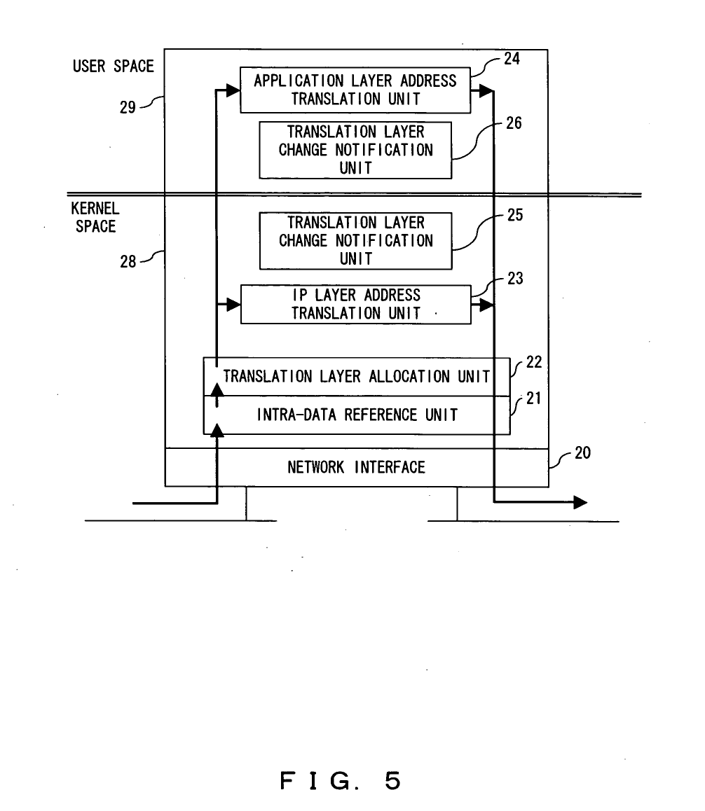

FIG. 5 is a block diagram showing the configuration of the address translation apparatus 10 shown in FIG. 4. In FIG. 5, the address translation apparatus 10 comprises- a network-interface 20 between two networks, an intra-data reference unit 21 for determination whether address translation is performed by the IP layer or an application layer by referring to the data unit of a packet, a translation layer allocation unit 22 for switching an address translation layer of a packet depending on the reference result, an IP layer address translation unit 23, an application layer address translation unit 24, a translation layer change notification units 25 and 26 for notification of a change of a translation layer from each layer.

When address translation is performed by the address translation apparatus 10 by the application layer, the translation corresponds to a translation in user space 29. When it is performed by the IP layer, the translation corresponds to a translation in kernel space 28.

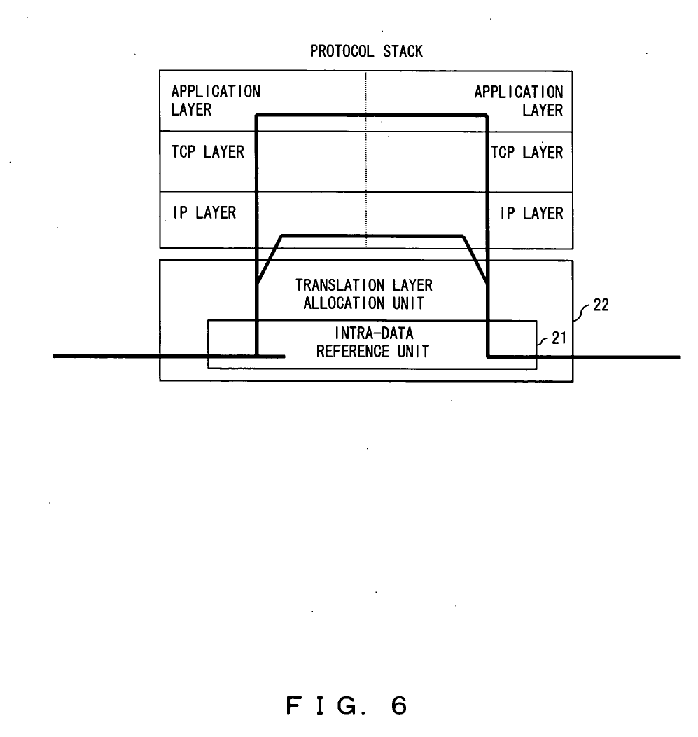

FIG. 6 is an explanatory view of the address translation system in which an address translation layer is selected for each packet. In FIG. 6, the translation layer allocation unit 22 selects for each packet an IP layer or an application layer as an address translation layer corresponding to the reference result of the data unit by the intra-data reference unit 21. By the IP layer, address translation is performed when data requiring address translation is not contained in the data unit. By the application layer, address translation is performed on a packet containing data requiring address translation in the data unit of the packet.

As described above, the case in which an address translation layer is selected for each packet corresponds to the first embodiment of the present invention.

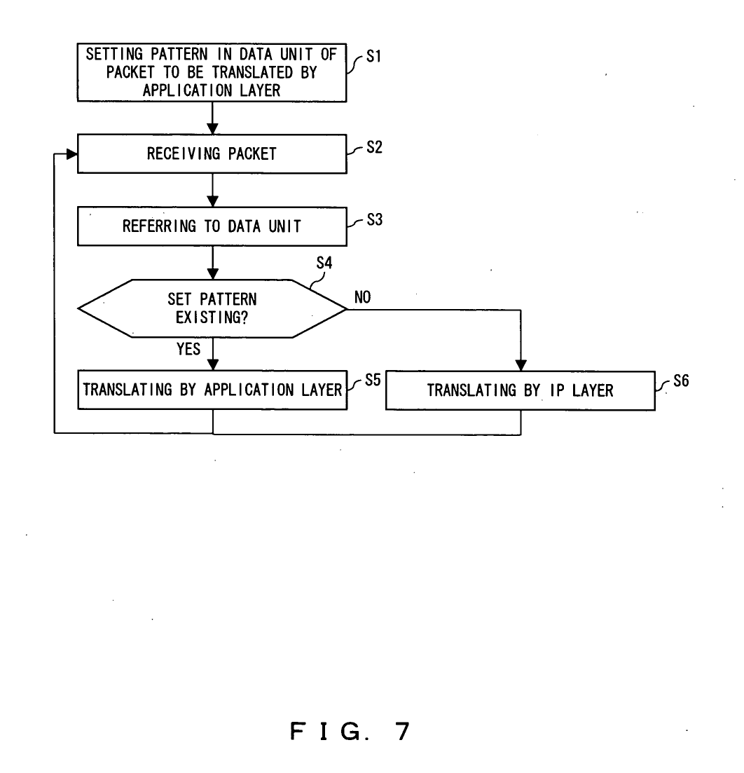

FIG. 7 is a flowchart of the basic process of the address translation system according to the first embodiment of the present invention. When the process starts as shown in FIG. 7, the pattern in the data unit of a packet or the type of packet to be address-translated by the application layer is set in step S1, and a packet is received in step S2, the data unit is referred to in step S3, it is determined step S4 whether or not the pattern set in the data unit exists or what the set packet type is, and the processes in and after step S2 are repeated after the address translation is performed by the application layer in step S5 if it exists, or after the address translation is performed by the IP layer in step S6 if it does not exist.

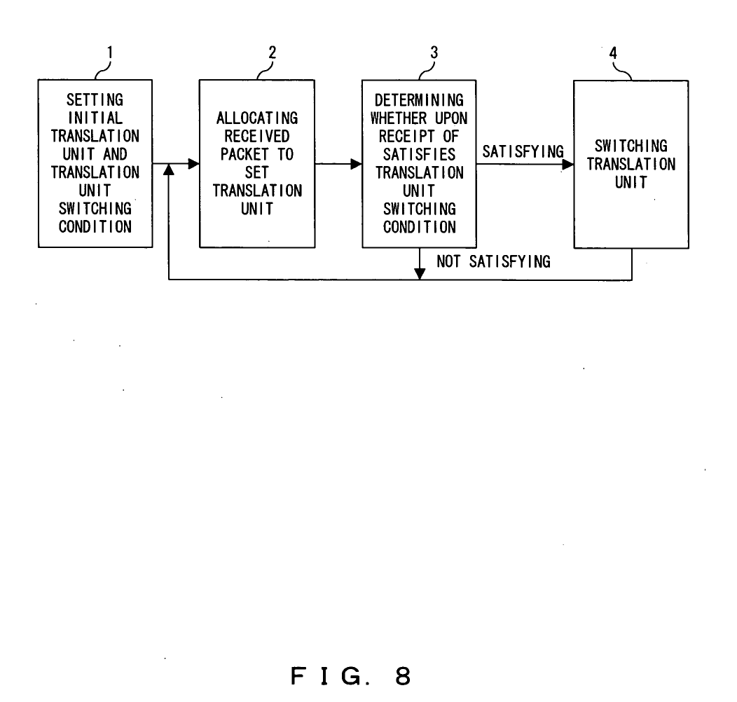

FIG. 8 is a block diagram showing the function in the principle of the address translation program corresponding to the second embodiment of the present invention. FIG. 8 shows the program executed by a computer comprising a plurality of address translation units, for example, an address translation unit for performing address translation by the IP layer, and an address translation unit for performing address translation by the application layer.

In FIG. 8, an address translation unit for performing address translation at the initial stage and a switching condition of the address translation unit for performing the address translation are set in 1, and a procedure of allocating a received packet to the set address translation unit is performed in 2.

Then, in 3, the procedure of determining whether or not the packet on which the address translation is performed is a packet satisfying the switching condition of the address translation unit described above. If it does not satisfy the switching condition, the process repeating procedure of repeating the packet allocating procedure in 2 and the subsequent procedures is performed.

When the switching condition of the address translation unit is satisfied, the packet allocating procedure in 2 and the subsequent procedures are repeated after the procedure of switching the address translation unit for performing address translation in 4 is performed.

In the above-mentioned procedure of determining the switching condition, a condition can be determined based on the contents of the application data in the packet on which address translation is performed. Corresponding to the second embodiment, a portable computer-readable storage medium storing an address translation program, an address translating method corresponding to the program, or the address translation apparatus for performing the address translation at the juncture of two networks having different address systems can be provided.

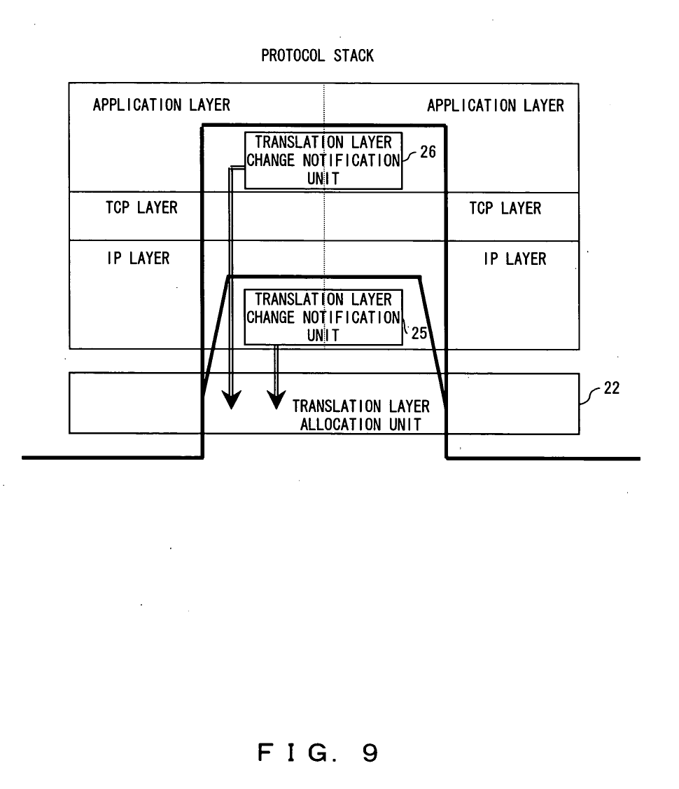

FIG. 9 is an explanatory view of the operation of the address translation system in which a translation layer is selected according to the second embodiment, that is, a notification from a modification notification unit provided for each layer. In FIG. 9, according to a notification from the change notification unit 25 provided for the IP layer, or the translation layer change notification unit 26 provided for the application layer, the translation layer allocation unit 22 changes the allocation of a packet.

For example, if the translation layer change notification unit 25 determines that address translation is to be performed by the application layer on a packet next to the packet on which address translation is performed by the IP layer, and if the determination result is provided for the translation layer allocation unit 22, then the address translation on the next packet is performed by the application layer.

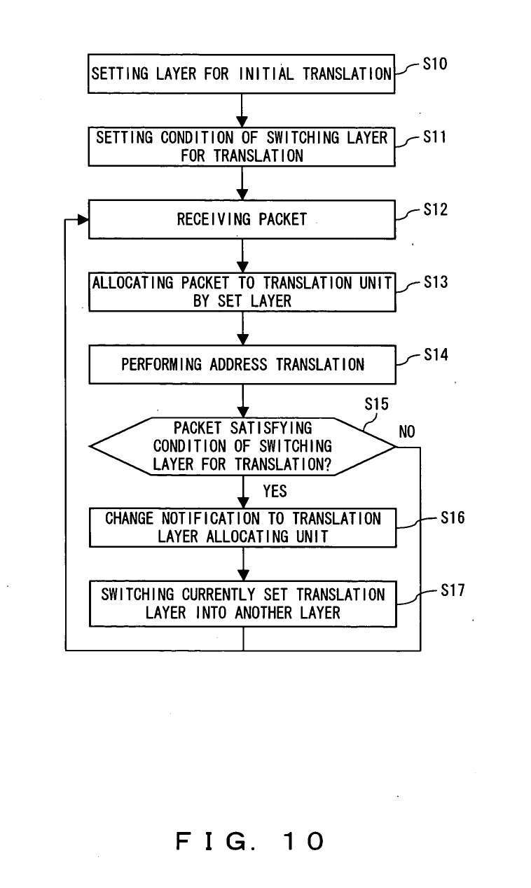

FIG. 10 is a flowchart of a basic address translating process according to the second embodiment. In FIG. 10, the layer by which address translation is to be performed in the initial stage is set in step S10. In this example, it is assumed that, for example, an application layer is set. Then, in step S11, the switching condition of the layer by which address translation is to be performed is set. Setting the condition is described later by referring to a practical example.

Then, a packet is received in step S12, a packet is allocated to an address translation unit in the layer currently being set, or to the address translation unit by the application layer in this example, that is, to the application layer address translation unit 24 in step S13, address translation is performed in step S14, it is determined in step S15 whether or not the received packet satisfies the switching condition for a layer by which address translation is to be performed, a change notification is issued to the translation layer allocation unit 22 in step S16 if the packet satisfies the condition, and the processes in and after step S12 are immediately repeated in step S17 if the condition is not satisfied in step S15 after the layer currently set as a layer by which address translation is performed is switched to another layer, that is, an IP layer in this example.

For explanation further in detail about the address translation system according to the present embodiment, three practical examples of communications processes performed between the host A 11 and the host B 12 shown in FIG. 4 are described below by referring to the respective applications.

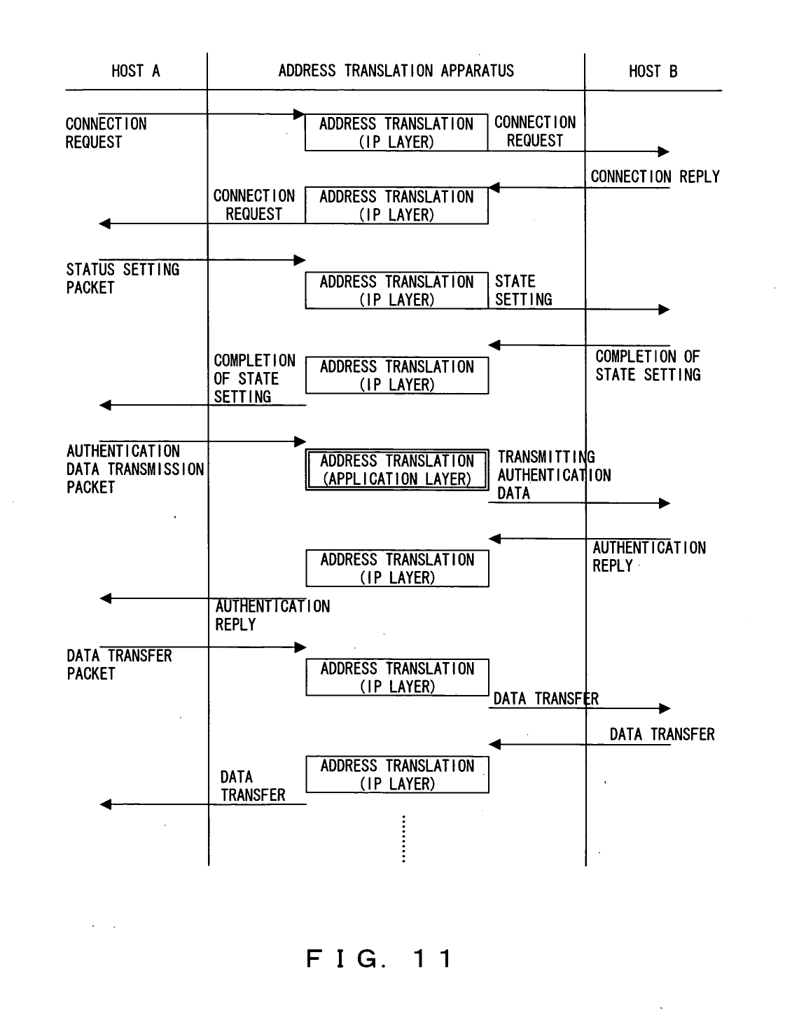

FIG. 11 is an explanatory view of the communications process in the application (1) as the first practical example. In the application (1), after the status is set between the hosts when the communications are started (after the connection of the communications), an authenticating operation is performed using an IP address, and a practical data transfer is performed after the authentication. An IP address for authentication is stored in the data unit of the packet only when the authentication is successfully performed. Therefore, address translation is required by the application layer only on an authentication data transmission packet, and address translation is performed by the IP layer on all other packets.

In FIG. 11, a connection reply packet is transmitted from the host B 12 corresponding to the connection request packet from the host A 11. Then, a status setting packet is transmitted from the host A 11, and a status setting completion packet is transmitted from the host B 12. The address translation on these packets are performed by the IP layer.

Then, an authentication data transmission packet is transmitted from the host A 11 to the host B 12. The packet is to be address-translated by the application layer. Then, the address translation on a data transfer packet between the host A 11 and the host B 12 is performed by the IP layer.

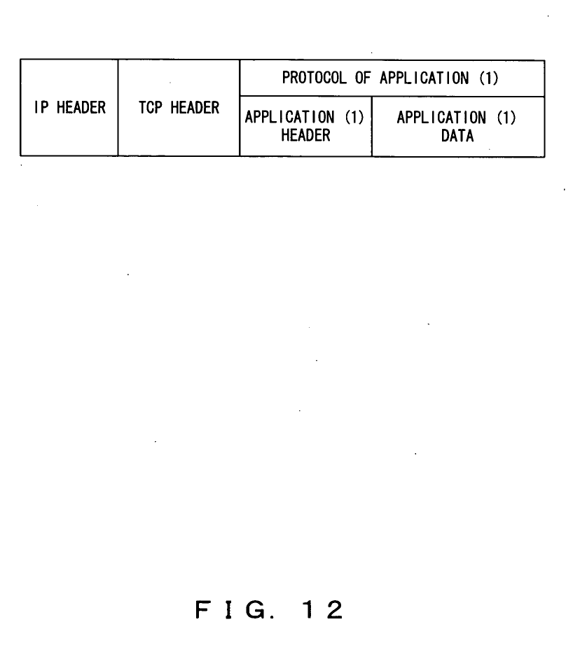

FIG. 12 shows the data structure of a packet used in the communications shown in FIG. 11. In FIG. 12, the packet first stores an IP header followed by a TCP header, the protocol of an application, an application header, and application data. The data portion of a packet is assumed to comprise an application header and application data.

The three examples of the applications, that is, the application (1) through (3), are identified by a destination port number in the TCP header. FIG. 12 shows the format of the TCP header. In FIG. 12, the destination port number is stored in the area in the third to fourth bytes from the head of the TCP header. It is assumed that the destination port number can be 1000 for the application (1), 2000 for the application (2), and 3000 for the application (3).

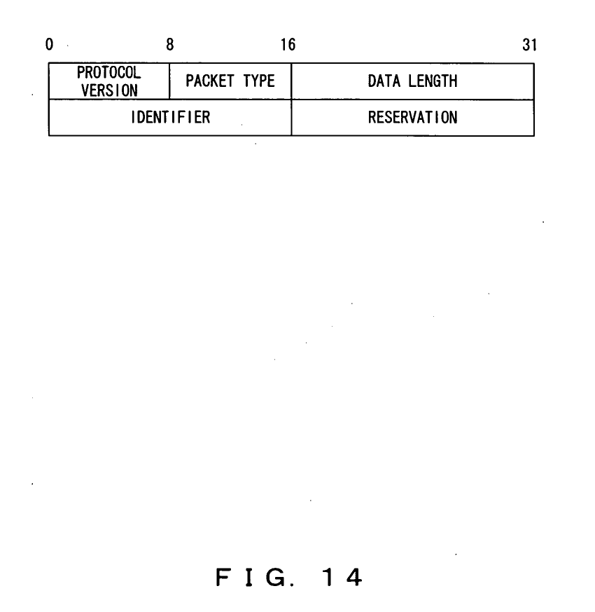

FIG. 14 shows the format of the application header shown in FIG. 12. This is an example of an application header for the application (1). The packet types respectively identifying the status setting packet, the authentication data-transmission packet, and the authentication data transmission packet are stored in the second byte from the head of the application header. When the value of the packet type is “1”, it indicates a status setting packet. When the value of the packet type is “2”, it indicates an authentication data transmission packet. When the value of the packet type is “3”, it indicates a data transfer packet.

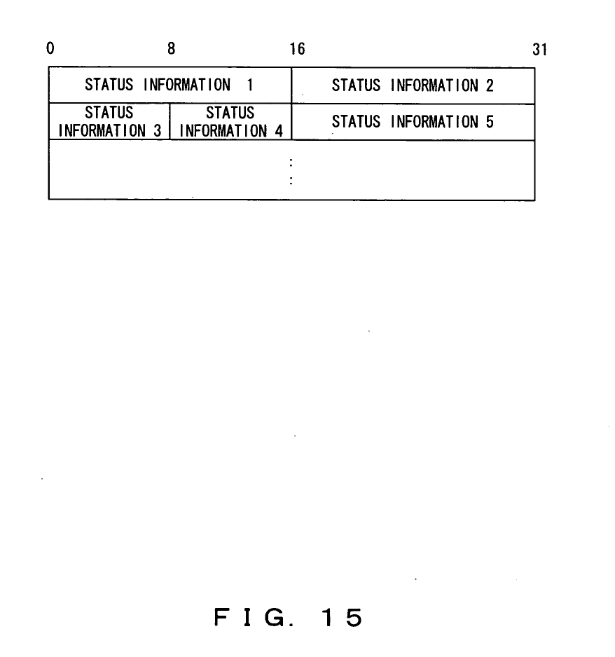

FIGS. 15 through 17 show the formats of the application data shown in FIG. 12. FIG. 15 shows the format of the application data of the packet whose packet type indicates a status setting packet, and various status information is stored as data.

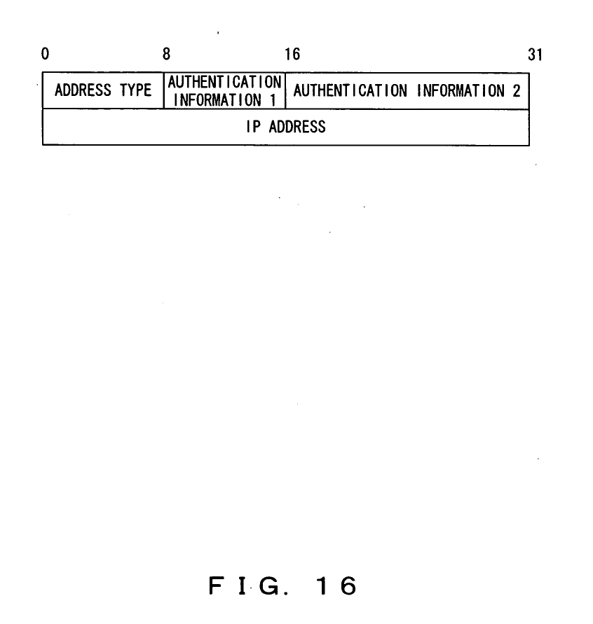

FIG. 16 shows the format of the application data for the authentication data transmission packet. In the fifth through eighth bytes from the head, an IP address is stored as the data for authentication.

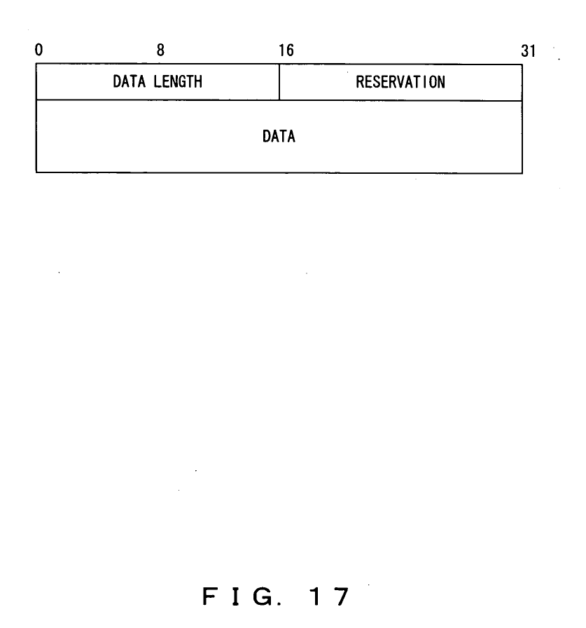

FIG. 17 shows the format of the application data in the data transfer packet, and the data actually transferred is stored after the area of the data length and a reservation.

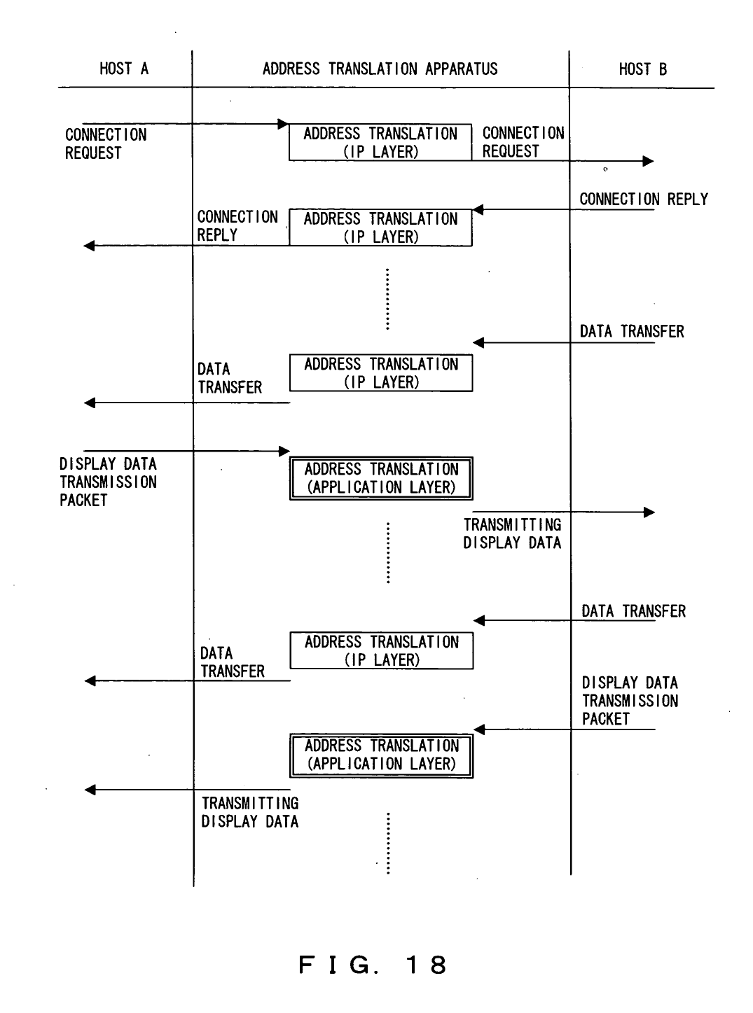

FIG. 18 is an explanatory view of the communications process of the application (2). In the application (2), an IP address is stored in the data portion of the packet with arbitrary timing to display to the user of the host of the partner side the IP address of the communications partner, the packet is transmitted to the host of the communications partner side, and communications are performed only on the display data transmission packet in the format requiring the address translation by the application layer.

In FIG. 18, when data is transmitted between two hosts after the connection request from the host A 11 and the connection reply from the host B 12, a display data transmission packet is transmitted from the host A 11 to the host B 12 with certain timing.

Then, after repeating communicating data transfer packets between the two hosts, a display data transmission packet is transmitted from the host B 12 to the host A 11 with certain timing. Only on the display data transmission packet, address translation is required in and application layer.

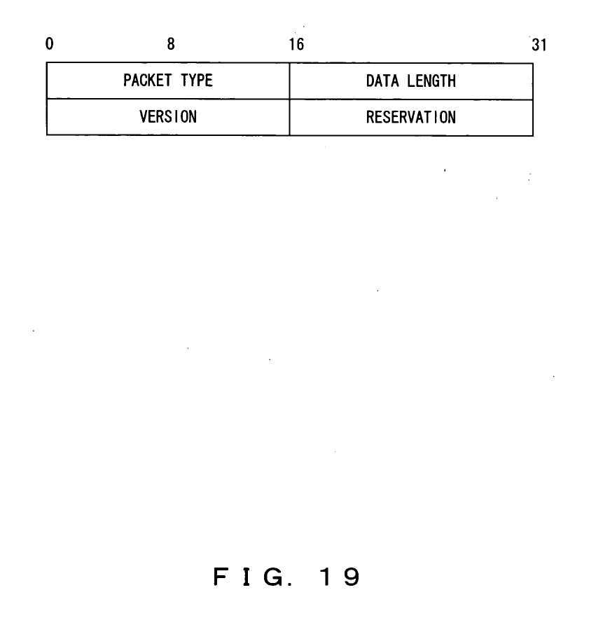

The data structure of a packet in the application (2) is the same as that shown in FIG. 12. FIG. 19 shows the format of the application header. Unlike FIG. 19, the packet type is stored in the two header bytes of the application header. When the value of the packet type is “1”, it indicates a display data transmission packet. When the value of the packet type is “2”, it indicates a data transfer packet.

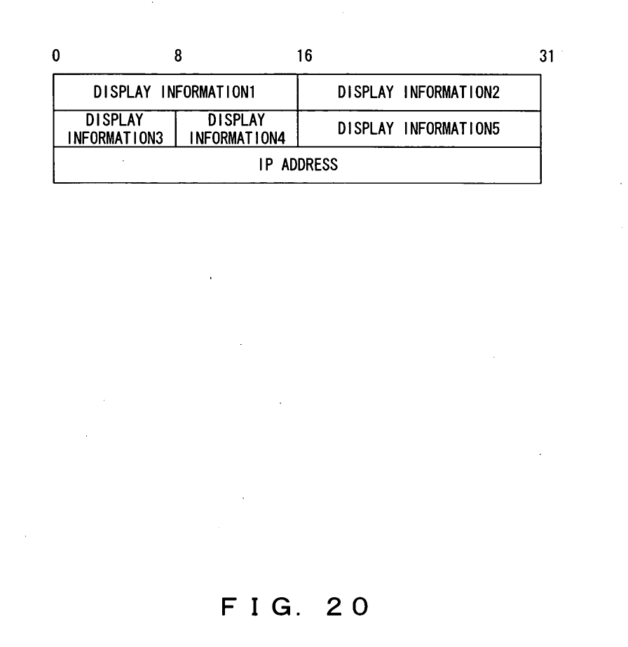

FIG. 20 shows the format of the application data of the display data transmission packet in the application (2). After each piece of display information, an IP address is stored in the ninth to twelfth bytes from the head. The format of the data transfer packet in the application (2) is the same as that shown in FIG. 17.

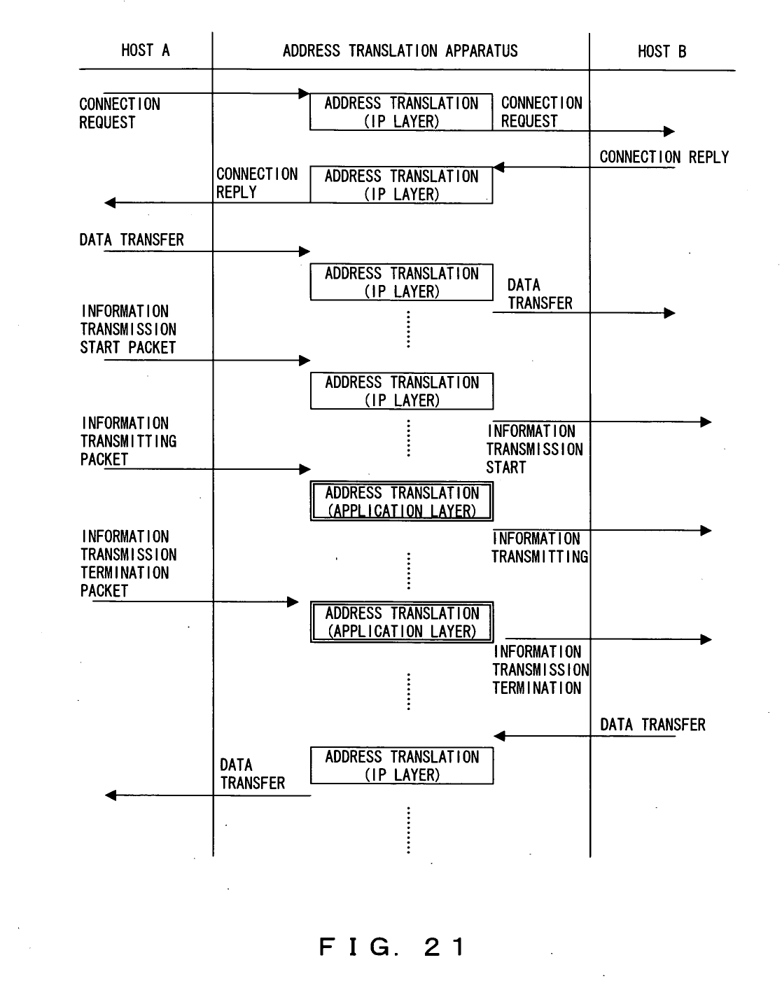

FIG. 21 is an explanatory view of the communications process in the application (3). In the application (3), data requiring address translation is not normally stored in the data portion of a packet, it is assumed that address translation is performed by the IP layer, data containing an IP address requiring address translation is transferred to a communications partner for a specified period, and only in this period, address translation is required by the application layer. The timing of starting and terminating the transfer of a packet requiring the address translation of the data portion of a packet is considered to be determined depending on a packet type.

In FIG. 21, after the connection request from the host A 11 and the connection reply from the host B 12, data is transferred between two hosts, and an information transmission start packet is transmitted from the host A 11 with certain timing.

The data portion of the information transmission start packet has not stored data requiring address translation, and the address translation is performed by the IP layer. When the translation is performed, the address translation apparatus determines that data requiring the address translation is stored in the data portion of a packet transferred to the host B 12 depending on the packet type of the information transmission start packet. The translation layer allocation unit 22 shown in FIG. 5 allocates a packet to the application layer address translation unit 24 starting with the next packet, and the address translation on the subsequent packets is performed by the application layer.

At this time, a packet transmitted from the host A 11 to the host B 12 immediately after the transfer of the information transmission start packet indicates a packet type of transmitting information. When the last packet containing data requiring the address translation in the data portion is transmitted, a packet indicating the packet type of termination of transmission of information is transmitted to the host B 12. When the address translation apparatus terminates the address translation on the packet, it determines that the address translation is to be performed by the IP layer from the next packet, and the translation layer allocation unit 22 allocates a packet to the IP layer address translation unit 23 from the next packet, and then address translation is performed by the IP layer.

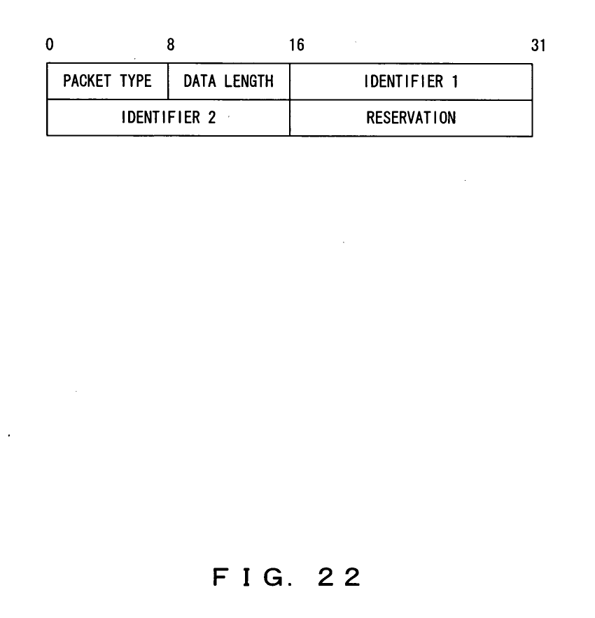

The data structure of the packet in the application (3) is the same as that of the application (1) as shown in FIG. 12. FIG. 22 shows a format of an application header, and the data indicating the packet type is stored in the header. When the value is “1”, it indicates the information transmission start packet. When the value is “2”, it indicates an information transmitting packet. When the value is “3”, it indicates the information transmission termination packet. When the value is “3”, it indicates a information transmission termination packet. When the value is 4, it indicates a data transfer packet.

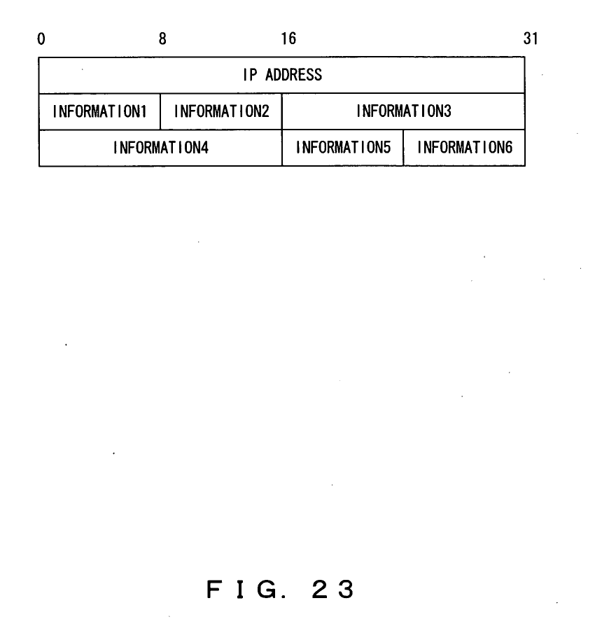

FIG. 23. shows the format of the application data in the information transmitting packet in the application (3) and the information transmission termination packet. An IP address is stored in the leading 4 bytes of the application data followed by various information.

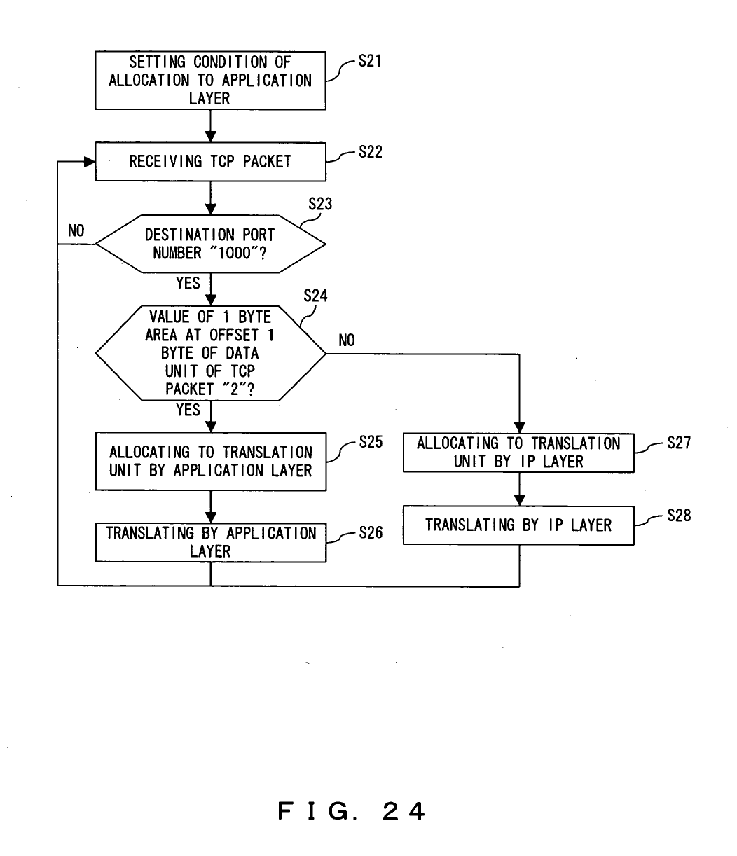

Then, the details of the address translating process in the second embodiment are explained below by referring to each of the applications (1) to (3). FIG. 24 is a flowchart of the address translating process on the application (1) according to the first embodiment.

In FIG. 24, the allocating condition of a packet to the application layer is set first in step S21. As the allocating condition, the condition that the value of the packet type of 1 byte is “2” is set.

In step S22, a TCP packet is received, and it is determined in step S23 whether or not the destination port number is 1000, that is, whether or not it is a communications packet for the application (1). If it is not 1000, the packet is not to be address-translated, for example, it is a packet to the apparatus, control is returned to step S22, and the next packet is received.

If the destination port number is 1000, it is determined in step S24 whether or not the packet type in the application header as the data portion of a packet is “2” as described above by referring to FIG. 14.

If it is “2”, then it is a authentication data transmission packet in the application (1), the packet is allocate to the application layer address translation unit 24 in step S25, the address translation by the application layer, that is, the translation of the IP address stored in the fifth byte of the application data described above by referring to FIG. 16 is performed in step S26, and then the processes in and after step S22 are repeated.

If the packet type is not “2” in step S24, then, as described above by referring to FIG. 14, the packet is a status setting packet or a data transfer packet, and the packet is allocated to the IP layer address translation unit 23 in step S27, the address translation is performed by the IP layer in step S28, and the processes in and after step S22 are repeated.

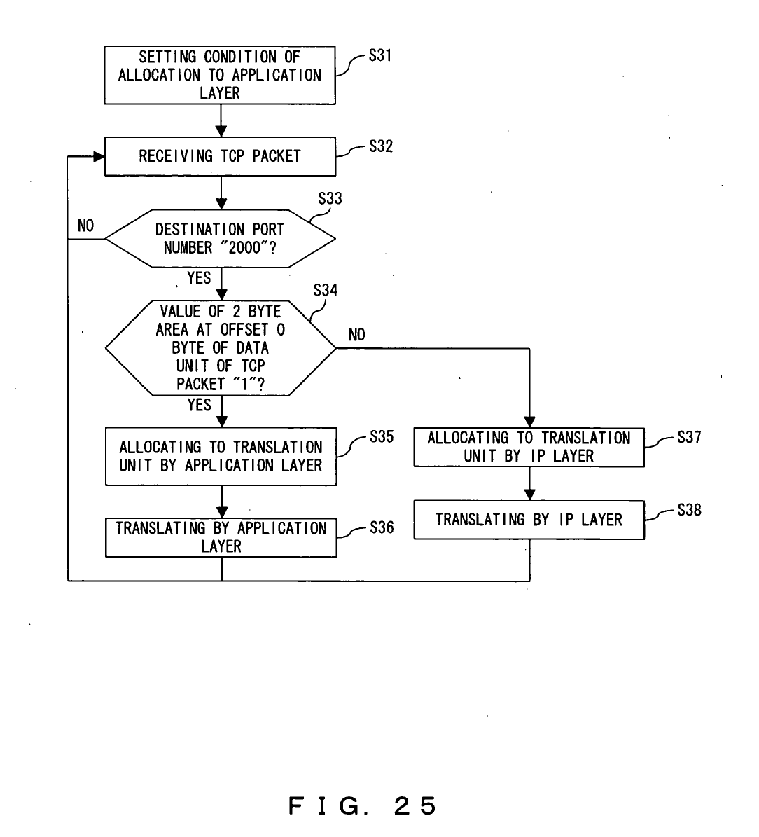

FIG. 25 is a flowchart of the address translating process for the communications process of the application (2) according to the first embodiment. In FIG. 25, the condition that the packet type is “1” as described by referring to FIG. 19 is set as the allocating condition for the application layer in step S31, a TCP packet is received in step S32, it is determined whether or not the destination port number is 2000 in step S33, and the processes in and after step S32 are repeated in step S33 if the number is not 2000.

If the destination port number is 2000, it is determined in step S34 whether or not the allocating condition to the application layer is satisfied, that is, whether or not the packet type is “1”. If it is “1”, then a packet is allocated to the application layer address translation unit 24 in step S35. After an IP address explained by referring to FIG. 20 is translated as the address translation by the application layer in step S36, and if the allocating condition to the application layer does not hold in step S34, the packet is allocated to the IP layer address translation unit 23 by the IP layer in step S37, the translation is performed by the IP layer in step S38, and then the processes in and after step S32 are repeated.

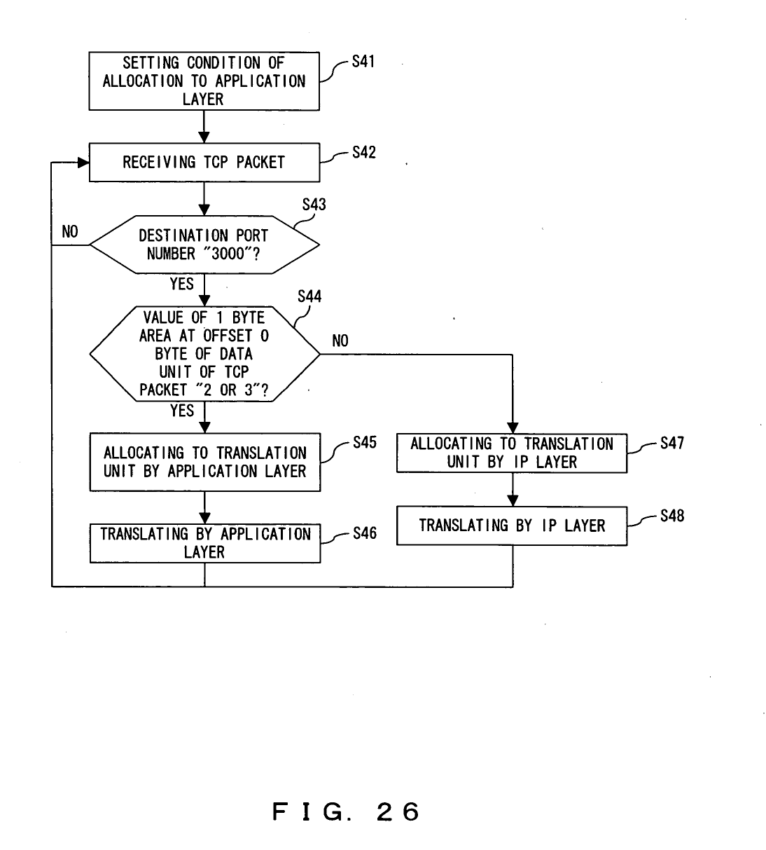

FIG. 26 is a flowchart of the address translating process for the communications of the application (3) according to the first embodiment of the present invention. FIG. 26 is similar to FIG. 26 showing the application (1) and FIG. 25 showing application (2), but is different in that the packet type described by referring to FIG. 22 as the allocating condition to the application layer is “2” indicating information being transmitted and “3” indicating the termination of information transmission in step S41, it is determined in step S43 whether or not the destination port number is 3000, it is determined in step S44 whether or not the packet type is “2” or “3”, and the translation of the IP address described by referring to FIG. 23 is performed by the application layer in FIG. 46.

The address translating process corresponding to each application according to the second embodiment is described below. In the second embodiment as described above, after the address translation is terminated on a packet, the layer by which the address translation is performed is switched starting with the next packet. Since it is hard to appropriately switch an address translating process for the application (2) in which the layer by which the address translation is performed on the packet is to be switched from the packet to be transferred with arbitrary timing, the address translation corresponding to the two applications, that is, the application (1) and the application (3), is explained below.

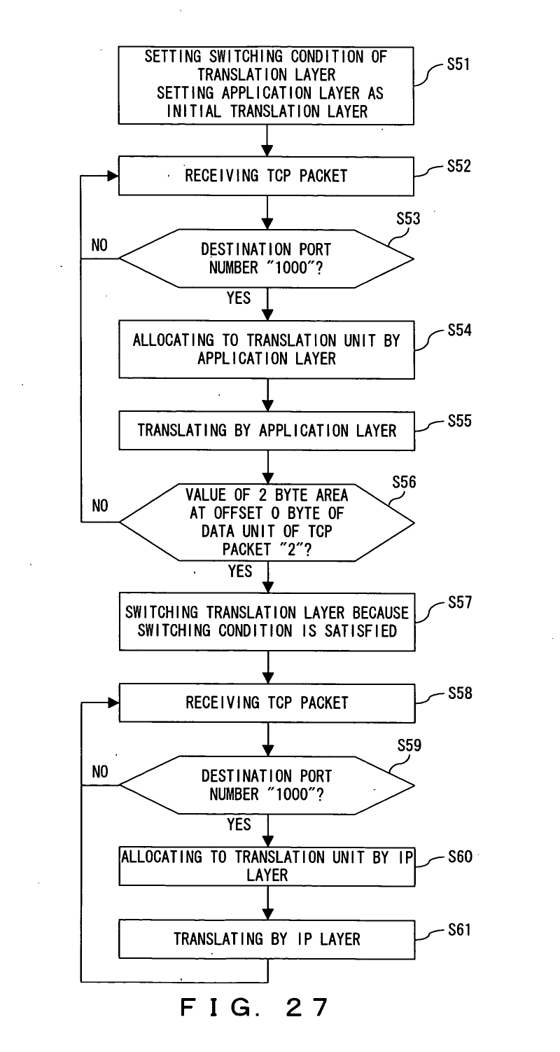

FIG. 27 is a flowchart of the address translating process on the communications of the application (1) according to the second embodiment of the present invention. In FIG. 27, an application layer is set as the initial translation layer in step S51, and a translation layer switching condition is also set. As the switching condition, performing the address translation of a packet whose packet type in the application header in a packet is “2” is set as a switching condition.

Then, in steps S52 and S53, the processes similar to those in steps S22 and 23 are performed, a packet is allocated to the application layer address translation unit 24 in step S54, the process similar to that in step S 26 is performed in step S55 as the address translation by the application layer, it is determined in step S56 whether or not the packet type of the packet address-translated is “2”, and the processes in and after step S52 are repeated if it is not “2”.

When the packet type is “2”, the address translation is performed on the authentication data transmission packet explained above by referring to FIG. 11. Therefore, the translation layer is switched with the switching condition assumed to have been satisfied in step S57. In FIG. 27, the application layer is set as an initial translation layer in step S51. For example, in FIG. 11, the address translation is to be performed only by the IP layer on the connection request packet, the connection reply packet, the status setting packet, and the status setting completion packet, but the address translation is performed by the application layer on these packets.

However, since the number of packets on which the address translation is performed by the application layer is small, and the influence on the total processing time is not so large, the address translation is applied to these packets by the application layer.

After the address translation layer is switched into the IP layer in step S57, the address translation is performed by the IP layer on the data transfer packet, that is, a large number of data transfer packets which are the subject of the communications as shown in FIG. 11 in steps S58 through S61.

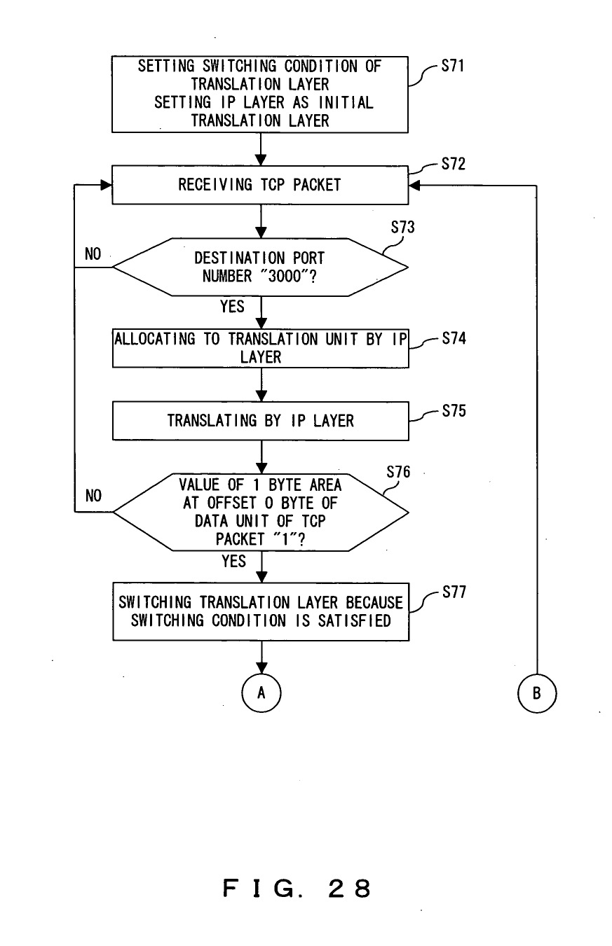

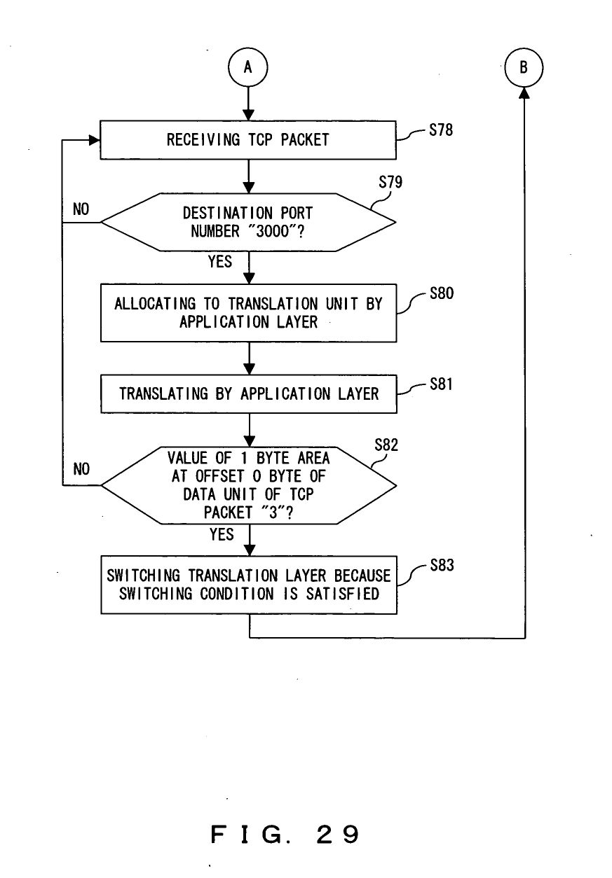

FIGS. 28 and 29 are flowcharts of the address translating process performed on the application (3). In FIG. 28, the IP layer is set as the initial translation layer, and the switching condition of a translation layer is set in step S71. The switching condition from the IP layer to the application layer is that the packet type of a packet on which the address translation is performed is “1”, and the switching condition from the application layer to the IP layer is that the packet type of the packet on which the address translation is performed is “3”.

Then, in steps S72 and S73, the processes similar to those in steps S42 and S43 are processed, a packet is allocated to the IP layer address translation unit 23 in step S74, the address translation is performed by the IP layer in step S75, and it is determined in step S76 whether or not the packet type of the translated packet is “1”. If it is not “1”, then the processes in and after S72 are repeated.

When the packet type is “1”, the switching condition is satisfied, and the translation layer is switched in step S77, that is, it is switched into the application layer, and then control is passed to the process shown in FIG. 29.

After the processes similar to those in steps S72 and S73 shown in FIG. 28 are performed in steps S78 and S79 shown in FIG. 29, the packet is allocated to the application layer address translation unit 24 by the application layer in step S80, the address translation is performed by the application layer in step S81 as in step S46 in FIG. 26, and then it is determined in step S82 whether or not the packet type of the address-translated packet is “3”, and the processes in and after step S78 are repeated when it is not “3”. When the packet type is “3”, the switching condition is satisfied, the translation layer is switched into the IP layer in step S 83, and then the processes after step S72 are repeated.

In the explanation above, the address translation by the application layer and the address translation by the IP layer are realized by software, but the address translation by the IP layer can be performed by hardware. Although the address translation by the IP layer is performed relatively at a high speed even by software, the configuration by hardware can further realize a high-speed operation.

In the embodiments above, the address translation program and the address translation apparatus according to the present invention are described in detail, but it is obvious that the address translation program can be configured based on a common computer system. FIG. 31 is a block diagram of the computer system, that is, a block diagram showing the configuration in a hardware environment.

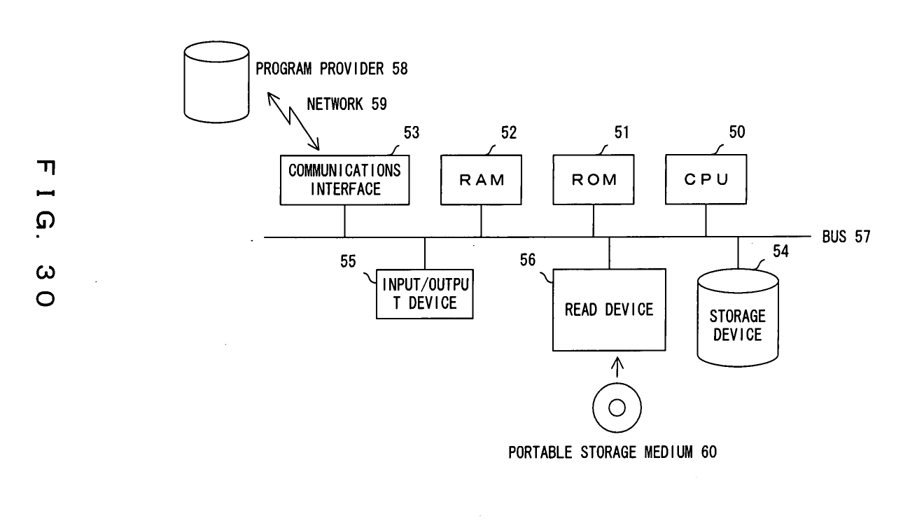

In FIG. 30, the computer system is configured by a central processing unit (CPU) 50, read only memory (ROM) 51, random access memory (RAM) 52, a communications interface 53, a storage device 54, an input/output device 55, a read device 56 of a portable storage medium, and a bus 57 to which all components are connected.

The storage device 54 can be variations of storage devices such as a hard disk, a magnetic disk, etc., and the storage device 54 or the ROM 51 stores programs shown in the flowcharts in FIGS. 7, 10, 24 through 29, etc., programs according to claims 1 through 4 of the present invention, etc. The programs are executed by the CPU 50, thereby possibly setting the address translation layer in the embodiments of the present invention.

The above-mentioned programs can be stored in, for example, the storage device 54 from a program provider 58 through a network 59 and the communications interface 53, or can be stored in a portable storage medium 60 sold and distributed in the market, set in the read device 56, and executed by the CPU 50. The portable storage medium 60 can be various storage media such as CD-ROM, a flexible disk, an optical device, a magneto-optical disk, a DVD, etc., and the programs stored in these storage media can be read by the read device 56, thereby changing the address translation layer for each packet according to the embodiments of the present invention.

According to the present invention, a data portion of a packet is referred to for each received packet, and it is determined whether the address translation is to be performed by the JP layer or the application layer, thereby realizing a high-speed address translation.

When the address translation is performed on a packet of the packet type into which the address translation is switched, the layer is switched into the one by which the address translation is performed. Thus, the address translation is performed first by the IP layer, and then the address translation is switched into the application layer as necessary, thus realizing a high-speed address translation in the entire communications.

In addition to the communications industries, the present invention is available in all industries in which communications system is used by performing address translation at the juncture of networks.

1. An address translation program used by a computer having a plurality of address translation units, said program causes said computer to perform:
a packet allocating procedure for allocating a received packet to a predetermined address translation unit;
a switching condition determining procedure for determining whether or not a packet on which address translation is performed is a packet satisfying a switching condition of a predetermined address translation unit;
a process repeating procedure for repeating said packet allocating procedure and subsequent procedures when the switching condition is not satisfied;
a procedure of switching an address translation unit for performing address translation when the switching condition is satisfied, and for repeating said packet allocating procedure and subsequent procedures.

2. The program according to claim 1, wherein
said plurality of address translation units comprises:
an address translation unit for performing address translation by an application layer; and
an address translation unit for performing address translation by an IP layer.

3. The program according to claim 1, wherein
in said switching condition determining procedure, a condition is determined depending on contents of application data in a packet on which the address translation is executed.

4. An address translation program used by a computer having a plurality of address translation units for performing address translation corresponding to a connection at which an application data portion of a packet containing data requiring address translation and an application data portion of a packet not containing data requiring address translation are transmitted to, said program causes said computer to perform:
a translation unit determining procedure for determining an address translation unit for performing address translation depending on contents of an application data portion of a received packet; and
a packet allocating procedure for allocating a received packet to the determined address translation unit.

5. A storage medium storing an address translation program used to direct a computer using a plurality of address translation units, said program causes said computer perform:
a packet allocating step for allocating a received packet to a predetermined address translation unit;
a switching condition determining step for determining whether or not a packet on which address translation is performed is a packet satisfying a switching condition of a predetermined address translation unit;
a process repeating step for repeating said packet allocating procedure and subsequent steps when the switching condition is not satisfied; and
a step for switching an address translation unit for performing address translation when the switching condition is satisfied, and for repeating said packet allocating step and subsequent steps.

6. A portable computer-readable storage medium storing an address translation program used by a computer having a plurality of address translation units for performing address translation corresponding to a connection at which an application data portion of a packet containing data requiring address translation and an application data portion of a packet not containing data requiring address translation are transmitted to, said program causes said computer to perform:
a step for determining an address translation unit for performing address translation depending on contents of an application data portion of a received packet; and
a step for allocating a received packet to the determined address translation unit.

7. An address translation apparatus having a plurality of address translation units, comprising:
a packet allocating unit allocates a received packet to a predetermined address translation unit;
a switching condition determining unit determines whether or not a packet on which address translation is performed is a packet satisfying a switching condition of a predetermined address translation unit;
a first control unit for repeating operations of said packet allocating unit and subsequent operations when the switching condition is not satisfied; and
a second control unit for switching an address translation unit for performing address translation when the switching condition is satisfied, and for repeating operations of said packet allocating unit and subsequent operations.

8. An address translation apparatus having a plurality of address translation units for performing address translation corresponding to a connection at which an application data portion of a packet containing data requiring address translation and an application data portion of a packet not containing data requiring address translation are transmitted to, comprising:
a translation determining unit for determining an address translation unit for performing address translation depending on contents of an application data portion of a received packet; and
a packet allocating unit for allocating a received packet to the determined address translation unit.

9. An address translating method using a plurality of address translation units, comprising:
allocating a received packet to a predetermined address translation unit;
determining whether or not a packet on which address translation is performed is a packet satisfying a switching condition of a predetermined address translation unit;
repeating of allocating the received packet to the predetermined address translation unit and subsequent operations when the switching condition is not satisfied; and
switching an address translation unit for performing address translation when the switching condition is satisfied, and repeating of allocating the received packet to the predetermined address translation unit and subsequent operations.

10. An address translating method for performing address translation corresponding to a connection at which an application data portion of a packet containing data requiring address translation and an application data portion of a packet not containing data requiring address translation are transmitted to, comprising:
determining an address translation unit for performing address translation depending on contents of an application data portion of a received packet; and
allocating a received packet to the determined address translation unit.
